(19) United States
(12) Patent Application Publication
(10) Pub. No.: US 2026/0018643 A1
(43) Pub. Date: Jan. 15, 2026

(54) POWER OUTLET ASSEMBLY FOR ELECTRIC STACK, PARTICULARLY FUEL CELL STACK

(71) Applicant: POWERCELL SWEDEN AB, 418 43 Gothenburg (SE)

(72) Inventor: Robin VELÉN, Hovas (SE)

(73) Assignee: POWERCELL SWEDEN AB, 418 43 Gothenburg (SE)

(21) Appl. No.: 18/994,289

(22) PCT Filed: Jul. 5, 2023
(86) PCT No.: PCT/SE2023/050703

§ 371 Date: Jan. 14, 2025

(30) Foreign Application Priority Data
Jul. 21, 2022 (SE) 2250925-1

(51) Int. Cl. H01M 8/248; H01M 8/0221; H01M 8/0297; H01M 8/1004; H01M 8/241

(52) U.S. Cl. CPC H01M 8/248; H01M 8/0221; H01M 8/0297; H01M 8/1004; H01M 8/241

(57) ABSTRACT

An electric cell stack assembly includes at least an electric energy generating cell stack body with a plurality of stacked unit cells. Each unit cell is a unit fuel cell includes a bipolar plate and a membrane electrode assembly, a first and second terminal plate sandwiching the cell stack body, which are adapted to collect the electric energy generated by the cell stack body. Each terminal plate includes a power output terminal, which is connectable to an external connector, and a tightening arrangement adapted to tighten the external connector to the power output terminal, for providing an electric connection between the external connector and the power output terminal. The tightening arrangement includes at least a first nut and a threaded element wherein the threaded element is adapted to be screwed into the first nut with a first end, and wherein the first nut is adapted to provide a tightening stop for the threaded element.

### BACKGROUND

### Background and Summary

The present invention relates to an electric cell stack assembly, particularly a fuel cell stack assembly.

Usually, an electric cell stack comprises a plurality of stacked electric cells, i.e. plates which are separated from each other by insulating layers. Thereby, electric energy is generated by each single cell and collected over the whole stack by current collector elements resp. plates.

In the special case of a fuel cell stack, the electric plates are bipolar plates and the insulating layers are multi-layer membrane electrode assemblies. The bipolar plates themselves are a combination of an anode plate and a cathode plate which are fixed to each other, wherein the bipolar plates are then separated, or with other words sandwiched, by the membrane electrode assemblies. The cathode and anodes plate which form the bipolar plates are usually electrically conducting metal or graphite plates, so called flow field plates, having a flow field for the reactants at one side and a flow field for a cooling fluid on the other side. In the assembled state of the membrane electrode assembly, the flow field plates are placed on top of each other in such a way that the cooling fluid flow fields are facing each other and the reactant fluid flow fields face the sandwiching membrane electrode assemblies. The electric current produced by the membrane electrode assemblies during operation of the fuel cell stack results in a voltage potential difference between the bipolar plate assemblies. Since the voltage difference of a single plate is quite small, a plurality of unit cells are stacked and the accumulated voltage difference is collected at the terminal plates.

For using the generated energy in a consumer, the terminal plates are equipped with so called power output terminals to which an external connector, e.g. a cable, may be fastened to provide an external consumer with electric energy.

For fastening the external connector to the power output terminal it is known to use screws or a nut and bolt combination which are tightened by a predetermined torque for ensuring a stable electric conductive connection between the external connector and the power output terminal.

For ensuring that only the power terminal remains electrically conducting and for ensuring that other parts of the electric stack, e.g. endplates, which sandwich the terminal plates, remain electrically isolated, as well as for avoiding any short circuit due to contact of the stack with the screw and for avoiding contamination of the stack with dirt or other impurities, which would deteriorate the stack's performance, but to provide an easy accessibility to the power output terminal, it is further known to arrange the power output terminal in a plastic housing or at least to provide a plastic cap which covers the screw on the stack facing side.

Thereby, the problem arises that if a thickness of the external connector is too small, the screw might be screwed in too far and then damages, particularly cracks, the plastic cover or housing, even if the screw is only tightened with the predetermined torque. This in turn results in the increased possibility that due to the damage in the insulation, other metallic parts of the fuel cell stack might become electrically conducting, e.g. the endplate or a compression element. Further, it might be possible that contaminants might enter the inside of the stack. On the other hand, if the thickness of the external connector is too large, the screw connection might not be tightened enough so that the screw might come loose, particularly if the stack is subjected to vibrations, e.g. due to an application in a vehicle.

It is therefore desirable to provide a fuel cell stack with a power outlet connection possibility which is customer friendly and easy to adapt to different sizes of external connectors.

In the following an electric cell stack assembly, particularly a fuel cell stack assembly, is disclosed, wherein the electric stack comprises at least an electric energy generating cell stack body with a plurality of stacked unit cells, i.e. electric plates which are separated from each other by insulating layers.

In the preferred embodiment of a fuel cell stack, each unit cell is a unit fuel cell comprising a bipolar plate as electric plate and a multilayered membrane electrode assembly as insulating and energy generating layer. The bipolar plates themselves are a combination of an anode plate and a cathode plate which are fixed to each other, wherein the bipolar plates are then separated, or with other words sandwiched, by the membrane electrode assemblies. The cathode and anode plates which form the bipolar plates are usually electrically conducting metal or graphite plates, so called flow field plates, having a flow field for the reactants at one side and a flow field for a cooling fluid on the other side. In the assembled state of the membrane electrode assembly, the flow field plates are placed on top of each other in such a way that the cooling fluid flow fields are facing each other and the reactant fluid flow fields face the sandwiching membrane electrode assemblies. The electric current produced by the membrane electrode assemblies during operation of the fuel cell stack results in a voltage potential difference between the bipolar plate assemblies.

For collecting and outputting the voltage, a first and a second terminal plate are provided which sandwich the cell stack body and are adapted to collect the electric energy generated by the cell stack body. Each terminal plate further comprises a power output terminal, which is connectable to an external connector.

Further, tightening means are provided which are adapted to tighten the external connector to the power output terminal, for providing an electric connection between the external connector and the power output terminal.

For providing a securely fastened connection between the power output terminal and the external connector and on the same time provide a connection possibility which is easily adaptable to different sizes of external connectors, the tightening means comprise at least a first nut and a threaded element, wherein the threaded element is adapted to be screwed into the first nut with a first end, and wherein the first nut is adapted to provide a tightening stop for the threaded element.

Thereby, the tightening stop provided by the first nut ensures that the threaded element is not screwed into the first nut too far for avoiding any damage on a housing covering the power output terminal and/or avoiding contact to the stack body.

According to an aspect of the invention, the threaded element is a threaded bolt and the tightening means further comprise a second nut, wherein the second nut is adapted to be screwed onto the threaded bolt at a second end and is adapted to be tightened by a predetermined torque for fixing the external connector to the power output terminal.

This also allows for the use of any kind of threaded bolt as no special requirements need to be met by the threaded bolt. The second nut in turn allows for a connection with a predetermined torque for ensuring a stable electrical connection. Thereby it is particularly preferred that the threaded bolt is a threaded rod. A threaded rod has a thread along its entire length and therefore provides a very flexible connection possibility for a wide range of different applications and external connector types. Of course it is also possible to further arrange any number of additional elements, e.g. distance elements, between the power output terminal and the second nut for fine tuning the electrical connection.

According to an aspect of the invention, the threaded element is a screw having a threaded screw body with a predetermined length and a screw head, wherein the predetermined length of the threaded screw body is set to such a length that the screw is adapted to be tightened by a predetermined torque for fixing the external connector to the power output terminal, when the tightening of the screw is stopped by the tightening stop.

According to an aspect of the invention, the tightening stop of the first nut is provided by a nut having an inner bore, wherein only a part of the inner bore is provided with a thread, wherein the inner diameter of the bore and the inner diameter of the thread are equal. Alternatively or additionally, the tightening stop of the first nut is provided by a blind nut, e.g. a cap nut, having an inner bore, which is designed as a blind hole with an inner thread. Thereby the use of an open nut is particularly preferred in applications, where the power output terminal is accommodated in an encompassing housing, wherein the use of the cap nut is also applicable to applications in which the power output terminal is only partly separated from the inside of the stack.

Preferably, the first nut is a square nut. This allows for a very good attachability for a tool and/or a side support by an optional encompassing housing so that an anti-rotation prevention for the first nut is provided.

According to an aspect of the invention, the tightening means is provided with a vibration loosening prevention. For that, the second nut may be a lock nut. Alternatively and/or additionally, the tightening means further comprise a vibration loosening preventing element, preferably a lockring or lock washer, wherein preferably the vibration loosening preventing element is arranged between the threaded element, e.g. the second nut or the screw head, and the power output terminal. Additionally or alternatively, the threaded element and/or the first nut and/or the second nut is equipped with a self-lock thread. Self-lock threads may have a modified thread profile having a ramp surface in the direction of stress, which provides the self-locking effect. Self-lock threads may also be defined by the angle of thread, which provides the thread with a preload force, when the thread is screwed into a material or a counterpart. This ensures that the external connector remains fastened to the power output terminal with the predetermined torque, also in vibrating environments, e.g. in vehicles or mobile applications.

According to an aspect of the invention, the electric stack further comprises a first and second insulation plate sandwiching the arrangement of cell stack body and the first and second terminal plates, wherein both the first and second insulation plate comprise a power output terminal housing, which is adapted to encompass the power output terminal of the corresponding terminal plate and electrically isolate the power output terminal from the outside. By encompassing the power outlet terminal by a housing, the power outlet terminal is physically separated from the inside of the stack, which provides a very good protection against external contamination while simultaneously providing a very good accessibility of the power output terminal from the outside.

Thereby, it is preferred that the first and second insulation plates and/or the power output terminal housing are made by molding from an electric isolating material, particularly from a plastic material. By molding the insulation plates and/or the power output terminal housing, also complex shapes can be easily formed.

Thereby, it is particularly preferred that the power output terminal housing is an integral part of the respective first and second insulation plates and formed during the molding of the insulation plates. This allows for a very good isolation of the stack against contaminants and a simply mounting process due to the reduced number of parts which need to be assembled.

According to an aspect of the invention, the power output terminal is bend by 90° from the planar extension of the terminal plate in direction of the corresponding insulation plate, and the power output terminal housing further comprises a slit into which the power output terminal is inserted so that the power output terminal is encompassed by the power output terminal housing. This also allows for a very good isolation of the stack against contaminants and a simply mounting process due to the reduced number of parts which need to be assembled. Additionally, this design is space saving as the power output terminal does not protrude from the stack.

Thereby, it is further preferred that a depth of the power output terminal housing and the location of the slit are arranged in such a way that the first nut is arranged between a bottom wall of the power output terminal housing and the power output terminal. This also allows for a space saving connectability of the external connector. Further, particularly in case the first nut is designed as square nut, the walls of the housing may be used as abutment for the first nut for providing an anti-rotation means.

Additionally or alternatively, the power output terminal housing comprises in a bottom area a pocket which shaped for at least partly accommodating the first nut. This also allows for an anti-rotation means for the first nut and further provides a space saving arrangement for the different parts of the electrical connection to an external connector. Further, the first nut can be arranged captive in the pocket.

It is further preferred that the power output terminal further comprises a through hole through which the threaded bolt is insertable and guidable to the first nut.

According to an aspect of the invention, the tightening means may further comprise a distance element for bridging a distance between the slit and the outside of the power output terminal housing. The distance element may be a sleeve having a square or circular shape and a through hole through which the threaded bolt is insertable and guidable to the power output terminal and further to the first nut.

Further embodiments are defined in the dependent claims as well as in the description and the figures. Thereby, elements described or shown in combination with other elements may be present alone or in combination with other elements without departing from the scope of protection.

### BRIEF DESCRIPTION OF THE DRAWINGS

In the following, preferred embodiments of the invention are described in relation to the drawings, wherein the drawings are exemplarily only, and are not intended to limit the scope of protection. The scope of protection is defined by the accompanied claims, only.

The figures show:

FIG. 1: a schematic illustration of a preferred embodiment of the electric cell stack in form of a fuel cell stack;

FIG. 2: an exploded view of a preferred embodiment of the power outlet arrangement;

FIG. 3: a schematic drawing of the power outlet arrangement illustrated in FIG. 2 in assembled form;

FIG. 4: a cross sectional view of a first embodiment for a first nut with a tightening stop; and

FIG. 5: a cross sectional view of a second embodiment for a first nut with a tightening stop.

### DETAILED DESCRIPTION

In the following same or similar functioning elements are indicated with the same reference numerals.

In the following, the principle of the invention is described for the case of a fuel cell stack. However, the principle can be likewise applied to any other kind of electric cell or electric cell stack. Further, features illustrated with regard to one embodiment may also be included alone or in combination in other embodiments.

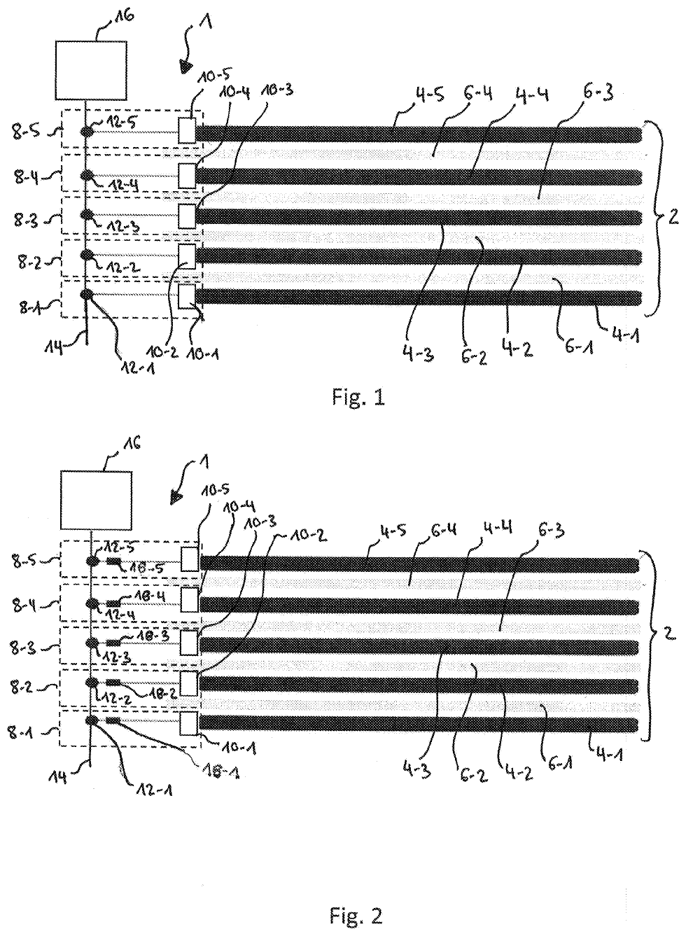

FIG. 1 illustrates an electric cell stack 100, wherein the electric cells stack is a fuel cell stack. The fuel cell stack 100 comprise a fuel cell stack body 2 with a plurality of alternatingly stacked bipolar plates 4 and multilayer membrane electrode assemblies 6.

Usually, each bipolar plate 4 is a combination of an anode plate and a cathode plate which are fixed to each other. Each anode and cathode plate has a front side and a back side, wherein the front or reactant side faces the adjacent membrane electrode assembly 6 and the back or coolant sides faces each other. Further each bipolar plate 4 has a plurality of openings for providing and discharging reactant and coolant to and from the bipolar plate 4. For distributing the reactant and coolant over the plate the bipolar plates may further have protruding structures which form fluid flow fields for the respective reactant/coolant. For sealing the flow fields to the environment, the plates are further equipped with so called bead seals which protrude from a basis of the plate and may also extend over the height of the flow field structures.

The membrane electrode assembly 6 is usually a multi-layer membrane electrode assembly, but is, for the sake of simplicity, only illustrated as single layer in the Figs. The membrane electrode assembly 6 may have the same or a similar shape as the bipolar plate 4, and has an active region (not shown) which is in the same area as the flow field region of the bipolar plate 4. The active region of the membrane electrode assembly 6, is usually the 3-layered electrode membrane assembly consisting of or comprising the membrane which is sandwiched between an anode and a cathode. The active region is preferably encompassed in a subgasket material, which surrounds and carries the active region of the 3-layer membrane electrode assembly, and electrically isolates the sandwiching bipolar plates. Additionally, the membrane electrode assembly may further comprise, on both sides gas diffusion layers (not illustrated), which are also arranged in the active region and cover the anode and cathode of the 3-layer membrane electrode assembly 6.

The electric current produced by the membrane electrode assemblies 6 during operation of the fuel cell stack 100 results in a voltage potential difference between the bipolar plate assemblies 4. Since the voltage difference of a single plate is quite small, a plurality of unit cells are stacked and the accumulated voltage difference is collected by so called terminal plates 8, which sandwich the fuel cell stack body 2, as illustrated in FIG. 1.

The terminal plates 8 in turn are electrically isolated to the outside by insulation plates 10, which sandwich the combination of fuel cell stack body 2 and terminal plates 8. The insulation plates 10 are usually made from an electrically isolating material, e.g. a plastic material, and may be covered by endplates 12. Alternatively, endplates 12 and insulation plates 10 are integrally formed. The endplates 12 may further be equipped with clamping means (not shown) which provide and maintain a pressure to the fuel cell stack body 2 which ensures its fluid tightness.

For using the generated energy in a consumer, the terminal plates 8 are equipped with power output terminals 14 to which an external connector, e.g. a cable, may be fastened for providing an external consumer with electric energy.

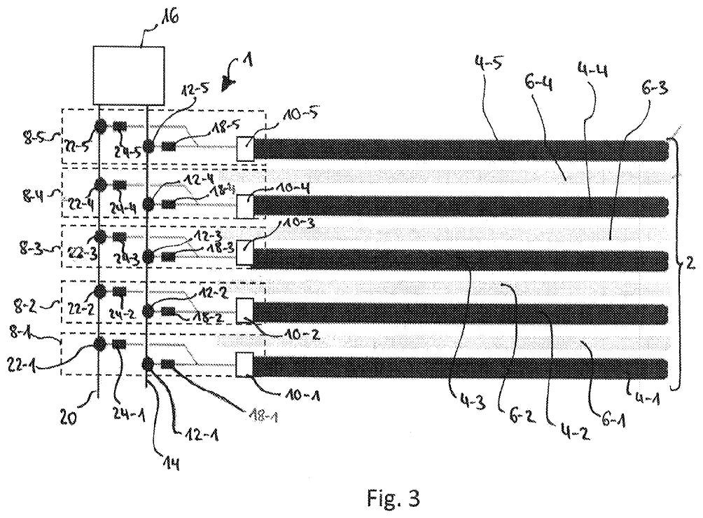

FIGS. 2 and 3 illustrate detailed views of such a connection possibility. Thereby, FIG. 2 illustrates an enlarged explosion view, whereas FIG. 3 illustrates an assembled state. As can be seen in FIG. 2, the terminal plate 8 has a power output terminal 14, which is bend by 90° from a planar extension of the terminal plate 8, wherein the planar extension is defined by surface 16. As is further illustrated in the preferred embodiment of FIG. 2, the power output terminal 14 is further equipped with a through hole 18, which is adapted to accommodate a tightening means 20 or part of a tightening means 20 for fastening the external connector (not illustrated) to the power outlet terminal 14, as will be explained in detail below.

In the illustrated embodiment, for providing a securely fastened connection between the power output terminal 14 and the external connector and on the same time provide a connection which is easily adaptable to different sizes of external connectors, the tightening means 20 comprises a first nut 22 and a threaded element 24. The tightening element 24 may be a screw (not illustrated). Thereby, a length of the screw may be predetermined depending on a predetermined torque, which is required for fixing the external connector to the power output terminal. Alternatively, and as illustrated in the embodiment of FIG. 2, the threaded element is a threaded bolt 24 and the tightening means further comprises a second nut 26 for fixing the external connector to the power output terminal 14.

Optionally, and as illustrated in the embodiment, the tightening means 20 may further comprise a distance element 23 for adapting the size of the threaded element to a size of the fuel cell stack and or a size of the external connector. The tightening means may further be provided with a vibration loosening prevention. For that, the second nut 26 may be a lock nut. Alternatively and/or additionally, the tightening means 20 may further comprise a vibration loosening preventing element such as a lockring or lock washer 25. Additionally or alternatively, the threaded element 24 itself and/or the first nut 22 and/or the second nut 26 is equipped with a self-lock thread. This ensures that the external connector remains fastened to the power output terminal with the predetermined torque, also in vibrating environments, e.g. in vehicles or mobile applications.

In the illustrated embodiment, the threaded bolt 24 is adapted to be screwed into the first nut 22 with a first end 27, wherein the second nut 26 is adapted to be screwed onto the threaded bolt 24 at a second end 28 and is adapted to be tightened by a predetermined torque for fixing the external connector to the power output terminal 14 (see also FIG. 3). Of course, it is also possible to arrange any number of additional elements, e.g. further distance elements 23 or lockrings 25, between the power output terminal 14 and the second nut 26 for fine tuning the electrical connection. Thereby, it is particularly preferred that the threaded bolt is a threaded rod. A threaded rod has a thread along its entire length and therefore provides a very flexible connection possibility for a wide range of different applications and external connector types.

As can be further seen in FIGS. 2 and 3, the insulation plate 10 is equipped with a power output terminal housing 30, which is adapted to accommodate the power output terminal 14 as well as at least parts of the tightening means 20. By encompassing the power outlet terminal 14 by the power output terminal housing 30, the power output terminal 14 is physically separated from the inside of the stack, which provides a very good protection against external contamination while simultaneously providing a very good accessibility to the power output terminal 14 from the outside.

Thereby it is preferred that the insulation plate 10 and/or the power output terminal housing 14 are made by molding from an electric isolating material, particularly from a plastic material. Preferably, the power output terminal housing 30 is an integral part of the insulation plate 10 and formed during the molding of the insulation plates. This allows for a very good isolation of the stack against contaminants and a simply mounting process due to the reduced number of parts which need to be assembled. Alternatively, it is of course also possible that the power output terminal housing 30 is a separate element which may be attached to the insulation plate 10 by any suitable means.

For accommodating the power output terminal 14, it is preferred that the power output terminal housing 30 is provided with a slit 32 into which the power output terminal 14 can be inserted. The power output terminal housing 30 further provides a bottom wall 34 and side walls 36 and 38, which are dimensioned in such a way that the power output terminal housing 30 forms a box around the power output terminal 14, when it is inserted into the slit 32.

As illustrated in FIG. 3, the bottom wall 34 of the power output terminal housing 30 is arranged in such a way that a distance d₁ between the bottom wall 34 and the location of the slit 32 are dimensioned in such a way that at least one element of the tightening means 20, particularly the first nut 22 may be arranged between the bottom wall 34 and the power output terminal 14 when it is inserted in the slit 32 in the assembled state.

In the illustrated embodiment, the first nut 22 is designed as square nut. It can be further seen in FIGS. 2 and 3 that at least the side walls 36 and 38 of the power output terminal housing 30 are dimensioned in such a distance to each other that the square nut 22 abuts the side walls 36 and 38. This allows for an anti-rotational arrangement of the first nut 22 in the power output terminal housing 30.

Additionally or alternatively, the power output terminal housing 30 may comprise a pocket in the bottom wall 34, which shaped for at least partly accommodating the first nut 22. This also allows for an anti-rotation feature of the first nut 22, but does not require a square nut. This also allows for a larger and not dimensionally adapted power output terminal housing 30 compared to the size of the first nut 22.

For ensuring that the power output terminal 14 is touch safely accommodated in the power output terminal housing 30, the slit 32 is also distanced by a distance d₂ from an open side of the power output terminal housing 30, as illustrated in FIG. 3. For bridging this distance d₂, the optional distance element 23 may be provided. The distance element 23 is then preferably made from an electrically conducting material.

As mentioned above, the threaded bolt 24 is adapted to be screwed into the first nut 22 with a first end 27, whereas the second nut in turn allows for a connection with a predetermined torque for ensuring a stable electrical connection. Since the threaded bolt 24 does not have an abutment part, such as a screw head, the threaded bolt could be screwed into the first nut 22 until it abuts at the bottom wall 34. However, even if a screw is used, a length of the screw might be too long, so that the screw head does not stop the tightening. In these cases the threaded bolt 24 or the screw may then accidentally being further screwed in the first nut 22, so that the bottom wall 34 might crack which compromises the electrically isolating characteristic of the insulation plate 10 as well as the overall stability. For avoiding damaging the insulation plate 10 or the power output terminal housing 30, the first nut 22 is adapted to provide a tightening stop 40 for the threaded bolt 24.

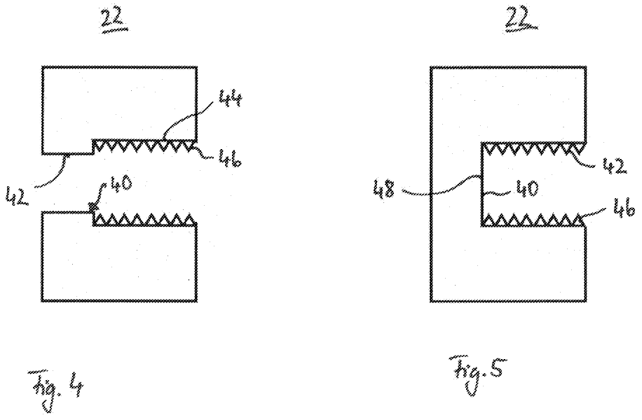

FIGS. 4 and 5 illustrate two different embodiments of the first nut 22 having such a tightening stop 40, wherein the illustrated nuts 22 are shown in a cross section. In the embodiment of FIG. 4, the tightening stop 40 is provided by a nut 22 having an inner bore 42, wherein only a part 44 of the inner bore 42 is provided with a thread 46, wherein the inner diameter of the bore and the inner diameter of the thread are equal. A threaded bolt can then only be screwed in the nut 22 until its end abuts the tightening stop 40.

In the embodiment of FIG. 5, the tightening stop 40 of the first nut 22 is provided by the first nut 22 being a blind nut, e.g. a cap nut, having an end wall 48, which serves as tightening stop 40 and terminates the inner bore 42 at one end. Thus the inner bore 42 is designed as a blind hole with an inner thread 46.

According to a further preferred embodiment, the tightening means 20 is further adapted to have locking capabilities for ensuring the connection does not come loose due to vibrations. For that, the second nut 26 may be designed as lock nut, and/or at least one of the threads, e.g of the screw or threaded bolt and/or of the nuts, is designed as self-locking thread. Alternatively or additionally and as illustrated in FIGS. 2 and 3, the tightening means 20 may comprises a locking washer 26. In the illustrated embodiment, the locking washer 26 is a wedge lock washer. Such a wedge lock washer is a two-piece washer with radial teeth on one side and wedging action of the halves where they join. While generally more expensive per piece, these washers provide the highest amount of vibrational loosening prevention.

By providing tightening means comprising at least a first nut and a threaded element, e.g. a screw, or a second nut in combination with a threaded bolt, wherein the first nut is provided with a tightening stop for the threaded element, a securely fastened connection between the power output terminal and the external connector may be provided which, on the same time, provides a connection which is easily adaptable to different sized of external connectors. This is due to the fact that thanks to the tightening stop at the first nut any kind of threaded element, e.g. screws, threaded bolts or threaded rods, may be used as no special requirements need to be met by the threaded element. Thereby, the tightening stop of the first nut ensures that the threaded element is not screwed into the first nut too far so that any damage on a housing covering the power output terminal may be avoided. This in turn ensures that other parts of the electric stack, e.g. an endplate, which are usually not electrically conducting remain electrically isolated so that the risk for getting an electric shock is minimized.

### REFERENCE NUMERALS

100 fuel cell stack
2 fuel cell stack body
4 bipolar plate
6 membrane electrode assembly
8 terminal plate
10 insulation plate
12 endplate
14 power output terminal
16 surface
18 through hole
20 tightening means
22 first nut
23 distance element
24 threaded element/threaded bolt
25 lock washer
26 second nut
27 first end of threaded bolt
28 second end of threaded bolt
30 power output terminal housing
32 slit
34 bottom wall
36, 38 side walls
40 tightening stop
42 inner bore
44 part of inner bore
46 thread

1. Electric cell stack assembly (100), particularly fuel cell stack assembly (100), comprising at least
an electric energy generating cell stack body (2) with a plurality of stacked unit cells, wherein preferably each unit cell is a unit fuel cell comprising a bipolar plate (4) and a membrane electrode assembly (4),
a first and second terminal plate (8) sandwiching the cell stack body (2), which are adapted to collect the electric energy generated by the cell stack body (2), wherein each terminal plate (8) comprises a power output terminal (14), which is connectable to an external connector, and
tightening means (20) which are adapted to tighten the external connector to the power output terminal (14), for providing an electric connection between the external connector and the power output terminal (14),
characterized in that
the tightening means (20) comprise at least a first nut (22) and a threaded element (24) wherein the threaded element (24) is adapted to be screwed into the first nut (22) with a first end (27), and wherein the first nut (22) is adapted to pro-vide a tightening stop (40) for the threaded element (24).

2. Electric stack according to claim 1, wherein the threaded element (24) is a threaded bolt and the tightening means (20) further comprise a second nut (24), wherein the second nut (24) is adapted to be screwed onto the threaded bolt at a second end (28) and is adapted to be tightened by a predetermined torque for fixing the external connector to the power output terminal (14).

3. Electric stack assembly (100) according to claim 2, wherein the second nut (24) is a lock nut.

4. Electric stack according to claim 1, wherein the threaded element (24) is a screw having a threaded screw body with a predetermined length and a screw head, wherein the predetermined length of the threaded screw body is set to such a length that the screw is adapted to be tightened by a predetermined torque for fixing the external connector to the power output terminal (14), when the tightening of the screw is stopped by the tightening stop (40).

5. Electric stack according to any one of the preceding claims, wherein the tightening stop (40) of the first nut (22) is provided by
a nut having an inner bore (42), wherein only a part (44) of the inner bore (42) is provided with a thread (46), wherein the inner diameter of the bore and the inner diameter of the thread (46) are equal; or
a cap nut having an inner bore (42), which is a blind hole with an inner thread (46).

6. Electric stack according to any one of the preceding claims, wherein the first nut (22) is a square nut and/or wherein the threaded bolt is a threaded rod.

7. Electric stack assembly (100) according to any one of the preceding claims, wherein the tightening means (20) further comprise a vibration loosening preventing element, preferably a lockring or lock washer (25), wherein preferably the vibration loosening preventing element is arranged between the threaded element (24) and the power output terminal (14), and/or wherein the threaded element (24) and/or the first nut (22) and/or the second nut (24) is equipped with a self-lock thread (46).

8. Electric stack assembly (100) according to any one of the preceding claims, further comprising a first and second insulation plate (10) sandwiching the arrangement of cell stack body (2) and the first and second terminal plates (8), wherein both the first and second insulation plate (10) comprises a power terminal housing (30), which is adapted to encompass the power output terminal (14) of the corresponding terminal plate (8) and electrically isolate the power output terminal (14) from the outside.

9. Electric stack assembly (100) according to claim 8, wherein the first and second insulation plates (10) and/or the power terminal housing (30) are made by molding from an electric isolating material, preferably from a plastic material.

10. Electric stack assembly (100) according to claim 8 or 9, wherein the power terminal housing (30) is an integral part (44) of the respective first and second insulation plates (10) and formed during the molding of the insulation plates (10).

11. Electric stack assembly (100) according to any one of claims 8 to 10, wherein the power output terminal (14) is bend by 90° from the planar extension (16) of the terminal plate (8) in direction of the corresponding insulation plate (10), and the power terminal housing (30) further comprises a slit (32) into which the power output terminal (14) is inserted so that the power output terminal (14) is encompassed by the power terminal housing (30).

12. Electric stack assembly (100) according to any one of claim 11, wherein a depth of the power terminal housing (30) and the location of the slit (32) are arranged in such a way that the first nut (22) is arranged between a bottom wall (34) of the power terminal housing (30) and the power output terminal (14).

13. Electric stack assembly (100) according to any one of claims 8 to 12, wherein the power terminal housing (30) comprises in a bottom wall (34) a pocket which is shaped for at least partly accommodating the first nut (22), wherein preferably the pocket has a complementary shape to the shape of the first nut (22).
